(19) United States
(12) Patent Application Publication
(10) Pub. No.: US 2012/0236441 A1
(43) Pub. Date: Sep. 20, 2012

(54) COMPRESSOR FOR AN AIR-CONDITIONER WITH A MOTOR PROTECTOR AND AN AIR-CONDITIONER

(76) Inventors: Jian Chen, Shanghai (CN); Bu Bin Bin, Taicang City (CN)

(21) Appl. No.: 13/420,879

(22) Filed: Mar. 15, 2012

(30) Foreign Application Priority Data
Mar. 18, 2011 (CN) 201110065891.5

(51) Int. Cl. H02H 7/00

(52) U.S. Cl. 361/22

(57) ABSTRACT

The present disclosure includes a compressor for use with an air-conditioner. The compressor includes a motor having a stator and a rotor. A compressing portion intakes gas, compresses gas and discharges gas. The compressor includes a protector located near the motor. The protector is connected in series to the circuit of the motor stator coil. The protector has a temperature sensitive element that trips the protector in response to the temperature sensitive element being heated to a predetermined drive temperature. A thermal resistance heater connects in parallel to the temperature sensitive element. The compressor can be includes with an air-conditioner, having an evaporator, a condenser, a throttling member and the compressor.

### CROSS REFERENCE TO RELATED APPLICATIONS

The present application claims the benefit of Chinese Patent Application No. 201110065891.5, filed on Mar. 18, 2011, entitled “Compressor For An Air-Conditioner With A Motor Protector And An Air-Conditioner,” which is incorporated herein by reference in its entirety.

### BACKGROUND

1. Technical Field

The present invention is directed to a compressor for an air-conditioner with a motor protector, in particular a compressor for an air-conditioner with a self-hold motor protector.

2. Description of the Related Art

A self-hold motor protector is commonly used in a compressor for an air-conditioner. The protector detects the over-current into the motor or surrounding temperature rising caused by abnormal operation of the compressor. The protector normally includes bi-metal element responsible to over-current or rising temperature. The protector cuts off the circuit in the case of over-load or over-heat operation so as to protect the motor from being destroyed. After the temperature decreases, the protector resets automatically and the motor re-starts accordingly.

In some special status, for instance the compressor starts under low voltage, the motor may be locked. However, since the locked current is low, the protector trips slowly but resets quickly. Thus the protector can easily fail due to frequently tripping and resetting, and the heat produced may burn the motor. To protect the motor from being burned due to failure of the protector in the locked status, there are strict provisions in the field of air-conditioning for the capability of the protector in motor locked status.

In the National Standards of the People's Republic of China—Safe Motor of House Used or Similar Used Electrical Appliance—Special Requirements for Compressor (GB 4706.17-2004/IEC 60335-2-34:1999), Section 19.101, Locker Rotor Endurance Test requests that motors with self-hold protector shall be subjected to an additional 15 days of operation or a total of 2000 cycles of operation shall be completed with the rotor locked.

In USA Standards “PROPOSED FIRST EDITION OF THE STANDARD FOR AUTOMATIC ELECTRICAL CONTROLS FOR HOUSEHOLD AND SIMILAR USE; PART 2: PARTICULAR REQUIREMENTS FOR THERMAL MOTOR PROTECTORS, UL 60730-2-2” has similar provisions requesting that motors with self-hold protector shall be subjected to an additional 15 days of operation or a total of 2000 cycles of operation shall be completed with the rotor locked.

To satisfy the requirements of the National Standards for motor and elongate the life time of motor, a person skilled in the art of air-conditioning is dedicated to improve the material and structure of the protector so as to increase the cycles of operation that the protector can be subjected to and prevent motor from burning as failure of the protector due to frequently tripping and resetting. That is to say that till now a person skilled in the art of air-conditioning is dedicated to increase the cycles of operation that the protector can be subjected to.

### SUMMARY

The present invention provides a new technique that is a revolutionary improvement to long-term knowledge in the art. The present invention is not directed to increase the cycles of operation that the protector can be subjected to. On the contrary, it is directed to decrease the cycles of operation that the protector needs at critical status (such as locked). Thus, a protector with lower capability (which can be subjected to less cycles of operation) can be applicable to a compressor for air-conditioner and has the same or even higher safety level.

In particular, in the present invention, if such as the motor is locked, once the protector trips, it will not automatically reset unless the user cuts off the power of the air-conditioner. Thus the motor will not be burned when locked due to frequently tripping and resetting of the protector. According to this new idea, even if the protector does not satisfy the standard that the protector shall be able to subject to at least 2000 cycles when the motor is locked, the compressor can safely operate when being locked.

The present invention is directed to a compressor for an air-conditioner, including: a motor comprised of a stator and a rotor; a compressing portion which intakes gas, compresses and discharges it; and a protector provided near to the motor, the protector being connected in series to the circuit of the motor stator coil and comprising a temperature sensitive element, and the protector trips when the temperature sensitive element is heated to a predetermined drive temperature, the protector further comprises an additional thermal resistance heater which connects in parallel to the temperature sensitive element.

The present invention is also directed to an air-conditioner, including: an evaporator, a condenser, a throttling member and the above-mentioned compressor.

### BRIEF DESCRIPTION OF THE DRAWINGS

The features and merits of the present invention will be clear by detailed description to the preferred embodiments with reference to the figures, wherein:

FIG. 1 shows a general structure of a prior protector;

FIG. 2 shows the compressor normally running condition, the protector is on the on position;

FIG. 3 shows the protector trips at the critical condition;

FIG. 4 shows when the users turn off the power, the protector will reset after a seconds;

FIG. 5 shows an enlarge view of the protector;

FIG. 6 shows an embodiment of the protector.

### DETAILED DESCRIPTION

An air-conditioner generally includes an evaporator, a condenser, a compressor and a throttling member. The compressor mainly includes: a motor comprised of a stator and a rotor, a compressing portion which intakes gas, compresses and discharges it; and a protector provided near to the motor, the protector being connected in series to the circuit of the motor stator coil.

The protector generally has two functions of over-current protection and over-heat protection:

Over-current protection: in the case that the winding current of the compressor motor is abnormal and exceeds the value set by the protector, the heat generated by the mental housing, the electric conduction plate and thermal sensitive bimetal sheet increases with the current. When the thermal sensitive bimetal sheet reaches a predetermined temperature, it turns over the movable contactor to be separated from the stationary contactor and turn off the motor winding circuit. Thus the motor is protected from being burned due to over current.

Over-heat protection: in the case that the temperature inside the compressor is too high, the heat sensitive bimetal sheet senses the temperature. When the thermal sensitive bimetal sheet reaches a predetermined temperature, it turns over the movable contactor to be separated from the stationary contactor and turn off the motor winding circuit. Thus the motor is protected from being burned due to over heat.

At present there are many types of house used compressor protectors for an air-conditioner. The protector includes an inner type and an outer type according to its mounting position and includes three-phase protector and single-phase protector according to the motor type. Each protector can be sub-divided into many types, such as an outer type 3/4″MP4AC and an inner type HM series by Sensata. The principle of the present invention is to add a electric resistance heater to the prior protector. The heater is connected in parallel to the temperature sensitive element of the protector. The temperature sensitive element is such a bimetal sheet.

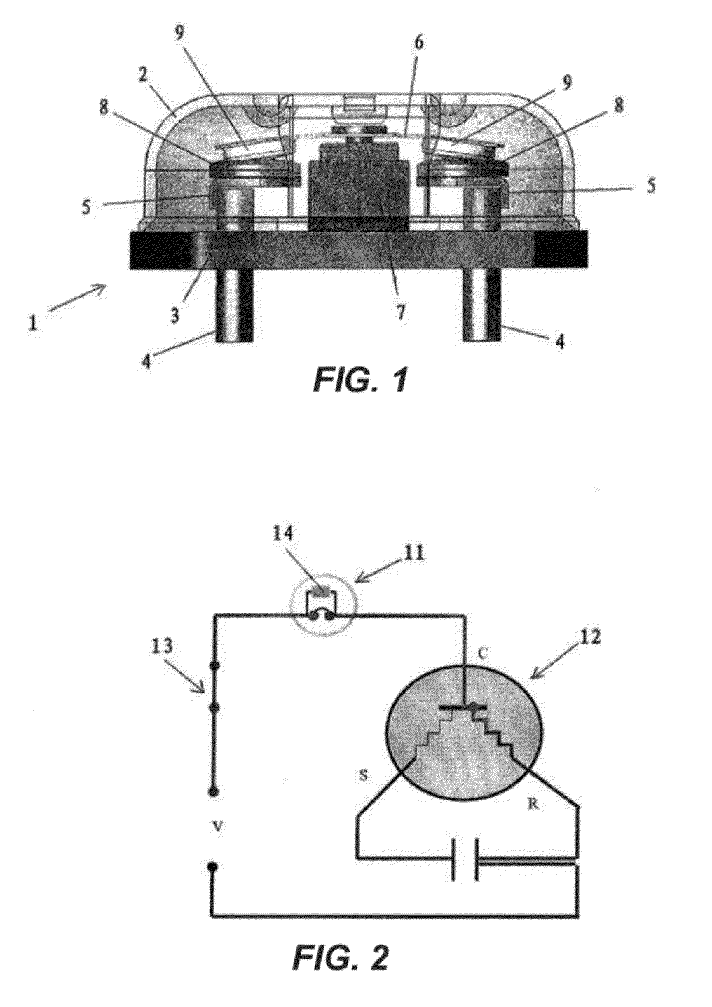

An inner type protector of the prior art is shown in FIG. 1. The protector comprises a curved header assembly 1 and cover 2, the header assembly consisting of a steel plate 3 and two stainless steel pins 4 insulated from the steel plate by glass to provide the connections for the three phases. Heaters 5 made of a conducive material are welded to the pins to provide heat to the bimetallic, snap-acting disc 6. The shape, material, and geometry of these heaters can be altered to provide a different amount of heat to the disc 6 as required. Electrical contacts 8 are welded to the top of these heaters. Another central heater, also made of a conductive material, is welded to the header. This heater can also be varied as necessary per the application. A disk assembly is welded to the top of this heater. The disc assembly consists of a bimetallic, snap-acting disc 6, with a slug 20c welded in the center and electrical contacts 9 located at the end of each side of the disc 6. The electrical contacts 9 on the disc 6 mate with those located on the heaters 16. During normal operation, disc 6 has an upwardly facing slightly convex configuration with contacts 9 in engagement with corresponding contacts 16b. However, when the disc 6 is heated to a selected actuation temperature, the disc 6 snaps to an opposite, and upwardly facing slightly concave configuration causing contacts 9 to move out of engagement with contacts 8. When the disk 6 then cools off to a selected reset temperature, lower than the actuation temperature, the disc 6 will then snap back to the upwardly convex dished configuration with the contacts 9 in engagement with corresponding contacts 8.

An inner type protector of the prior art is introduced above. However, the present invention is not limited to an improvement to the above-mentioned protector but also relates to an improvement to an outer type protector. In particular, an outer type protector of the prior art, such as 3/4″MP by Sensata, has two terminals connected to the circuit, one terminal connected to the power and the other terminal connected to the compressor. The core part is a heat generating wire and a bimetal sheet connected in series between the terminals. The bimetal sheet trips when the temperature is too high so as to disconnect the circuit. The bimetal sheet automatically resets when the temperature returns to a preset temperature and reconnects the circuit.

According, in a detailed embodiment of the present invention, a heat resistance heater, preferably a PTC thermistor heater, is connected parallel to the traditional self-hold protector. PTC shall satisfy 120V and 240 V respectively depending on the electric power. The power of PTC is selected to satisfy the self-hold function. After the protector trips, PTC generates heat so as to satisfy the self-hold requirements. That is, the temperature due to heat generation shall be higher than the preset reset temperature of the protector. According to the application range of the compressor, the reset temperature of the protector is set from 60° to 90°. Thus the temperature due to heat generation by PTC shall be higher than 90° after the protector trips.

The power of PTC is selected to 1-5 W, preferably 2 W for an outer type protector, based on the above-mentioned principle. If the power is selected too high, the temperature will be too high so that the bimetal sheet is easy to destroy. If the power is selected too low, the function of secure disconnection cannot be realized. According to FIG. 2, the protector 11 is connected in series to the circuit of the motor stator windings 12. The power switch turns on, the protector turns on, the PTC heater 14 has low resistance and is bypassed, and the compressor normally operates.

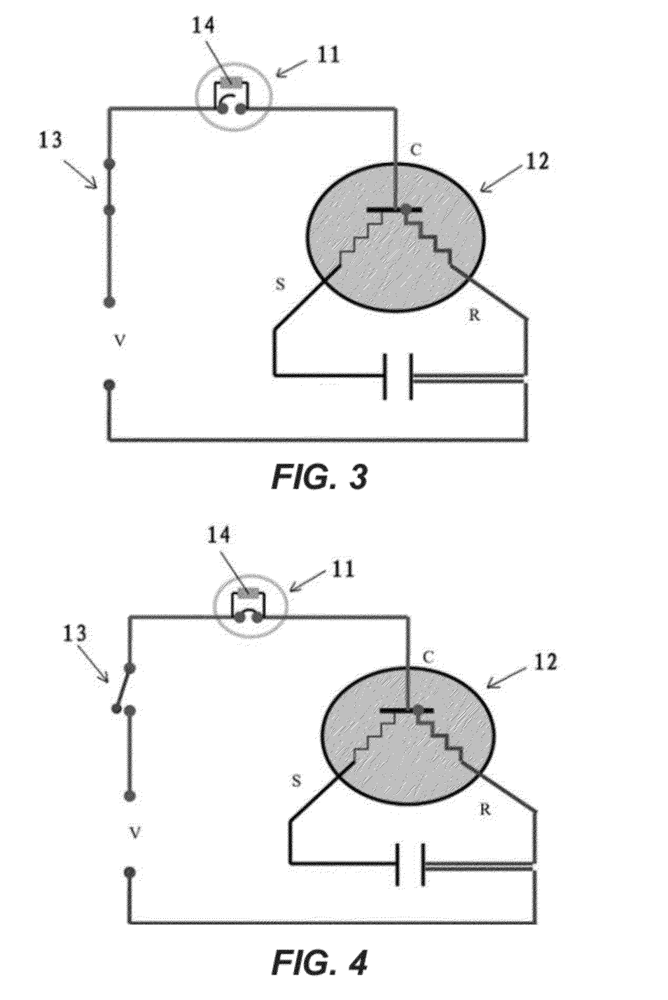

FIG. 3 shows at critical conditions, such as temperature rising due to compressor locked, when the heat sensitive bimetal sheet of the protector 11 is heated to a selected drive temperature, the protector 11 trips. At this time, since the circuit power switch 13 turns on, there is voltage between protector's two sides and thus the temperature of PTC heater 14 increases with the resistance increases dramatically accordingly so as to limit the current. Thus the compressor keeps not operating so that there is no risk that the motor burns due to over heating. At the same time, the PTC heater 14 generates heat to keep the protector tripping.

As shown in FIG. 4, only when the power switch 13 is turned off, such as by the user, there is no voltage between protector's two sides. Thus, after the bimetal sheet in the protector 11 cooled to a reset temperature lower than the drive temperature, the protector 11 automatically reset. The PTC heater 14 decreases in temperature and returns to low resistance. After the user turns on the power again, the air-conditioner starts to operate normally.

In addition, the protector of the above embodiment is used to protect three-phase motor. However, it can also be used to protect single-phase motor. In particular, in single-phase application, the PTC is connected in parallel to the protector body; in three-phase application, PTC is connected in parallel to any two phases.

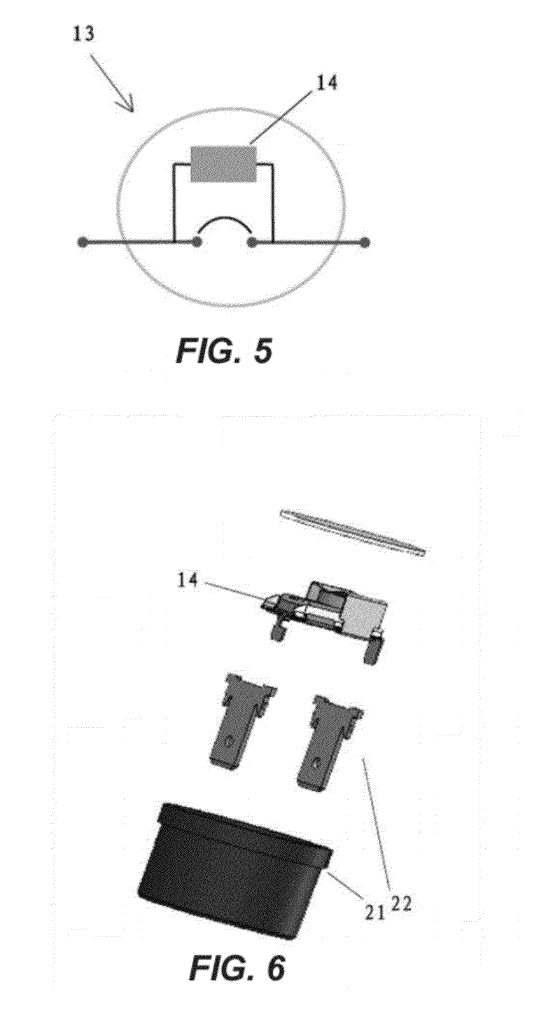

FIG. 5 shows an enlarged view of the present protector, wherein PTC heater 14 is connected in parallel to the protector 11.

FIG. 6 shows a detailed embodiment of the structure of the present protector. The protector includes a base 21 and two terminals 22. Thermal sensitive bimetal sheet is included in the base 21 and two terminals 22 are connected in series to the motor winding circuit. The protector further comprises a PTC heater 14 which is connected in parallel to the two ends of the thermal sensitive bimetal sheet.

However, the present protector is not limited to the above structure and the protector falls into the present invention as long as it satisfy the following condition: once the protector trips, only when the thermal sensitive bimetal sheet cools to a preset reset temperature lower than a preset drive temperature and the power is cut off, the protector automatically resets. The design of the present invention does not change the customs of the present compressor manufacturer and air-conditioner manufacturer.

According to the present protector, at critical conditions such as motor locked, the protector will not frequently trip and reset and burn the motor. According to this new idea, the requirements to the operation capability of the cycles of the air-conditioner compressor can be decreased. Thus, a protector with fewer cycles can be used to satisfy the safety requirements of the compressor with reduced cost. Even if the protector does not satisfy the provisions in the Standard that the protector shall be able to be subjected to at least 2000 cycles when motor is locked, it can still guarantee the safe operation of the compressor for a long time when motor is locked.

Only preferred embodiments of the present invention are illustrated above. However, what shall be pointed out is, for a person skilled in the art, it is possible to make various modifications and variations without departing away from the spirit of the present invention, and these modifications and variations shall be regarded as falling into the protection and scope of the present invention.

1. A compressor for an air-conditioner, the compressor comprising:
a motor comprised of a stator and a rotor;
a compressing portion that intakes gas, compresses gas and discharges gas; and
a protector positioned adjacent to the motor, the protector being connected in series to a circuit of a motor stator coil, the protector comprising a temperature sensitive element, the protector being configured such that the protector trips in response to the temperature sensitive element being heated to a predetermined drive temperature, the protector including a thermal resistance heater that connects in parallel to the temperature sensitive element.

2. The compressor of claim 1, wherein the electric resistance heater is a PTC resistance heater.

3. The compressor of claim 2, wherein in response to the temperature sensitive element tripping the protector, a temperature of the PTC resistance heater increases sufficiently such that that the protector is kept tripping.

4. The compressor of claim 1, wherein the temperature sensitive element is a thermal sensitive bimetal sheet.

5. The compressor of claim 2, wherein circuit power is cut off in response to receiving manual input that resets the protector.

6. The compressor of claim 5, wherein subsequent to circuit power being cut off, a temperature of the temperature sensitive element decreases to a predetermined temperature that resets the temperature sensitive element, and the temperature of PTC resistance heater decreases until returning to a low resistance.

7. The compressor of claim 6, wherein the temperature sensitive element is a thermal sensitive bimetal sheet.

8. The compressor of claim 7, wherein in response to the temperature sensitive element tripping the protector, a temperature of the PTC resistance heater increases sufficiently such that that the protector is kept tripping.

9. The compressor of claim 8, wherein the protector is selected from the group consisting of an inner type protector and an outer type protector.

10. The compressor of claim 9, wherein the motor is selected from the group consisting of three-phase motor and single-phase motor.

11. The compressor of claim 10, further comprising:
an air-conditioner, the air-conditioner including an evaporator, a condenser, a throttling member and the compressor.

12. The compressor of claim 1, wherein the protector is selected from the group consisting of an inner type protector and an outer type protector.

13. The compressor of claim 2, wherein a power of the PTC resistance heater is 1-5 W.

14. The compressor of claim 13, wherein the power of the PTC resistance heater is 2 W.

15. The compressor of claim 1, wherein the motor is selected from the group consisting of three-phase motor and single-phase motor.

16. The compressor of claim 1, further comprising:
an air-conditioner, the air-conditioner including an evaporator, a condenser, a throttling member and the compressor.

17. A compressor for an air-conditioner, the compressor comprising:
a motor comprised of a stator and a rotor;
a compressing portion that intakes gas, compresses gas and discharges gas; and
a protector provided near to the motor, the protector being connected in series to a circuit of a motor stator coil, the protector comprising a temperature sensitive element, the protector trips when the temperature sensitive element is heated to a predetermined drive temperature, characterized in that, the protector further comprises an additional thermal resistance heater which connects in parallel to the temperature sensitive element.
